(19) United States
(12) Patent Application Publication
(10) Pub. No.: US 2006/0231318 A1
(43) Pub. Date: Oct. 19, 2006

(54) High impact fire proctection system

(76) Inventor: Tommy Glen Noble, Hindman, KY (US)

Correspondence Address: Tommy Glen Noble, P.O. Box 190, Hindman, KY, 41822, US

(21) Appl. No.: 10/853,399

(22) Filed: Apr. 11, 2005

(51) Int. Cl. B60K 28/00; A62C 3/07; A62C 3/08; B60K 28/14; B60R 21/00

(52) U.S. Cl. 180/271; 169/62; 180/284

(57) ABSTRACT

My system would offer fire protection by spraying fire retardant in and under motor compartment and also on and around gas tanks by one of these three ways: 1. Smoke Detector/Heat Sensor 2. Impact Switches due to collision/crash of automobile 3. A manual switch on dash of automobile

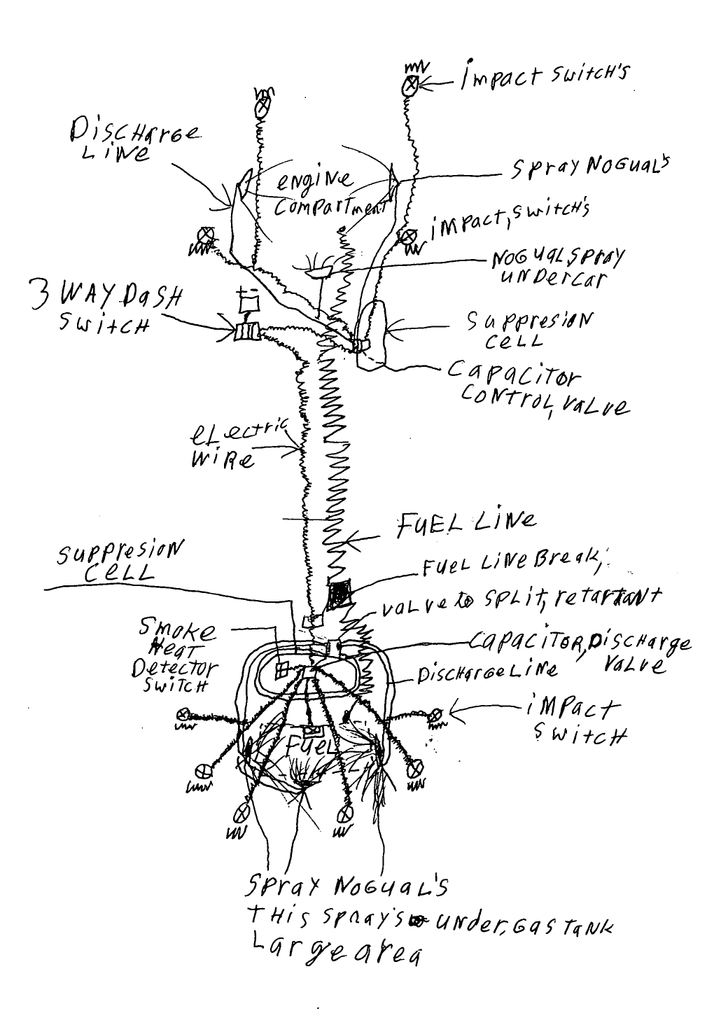

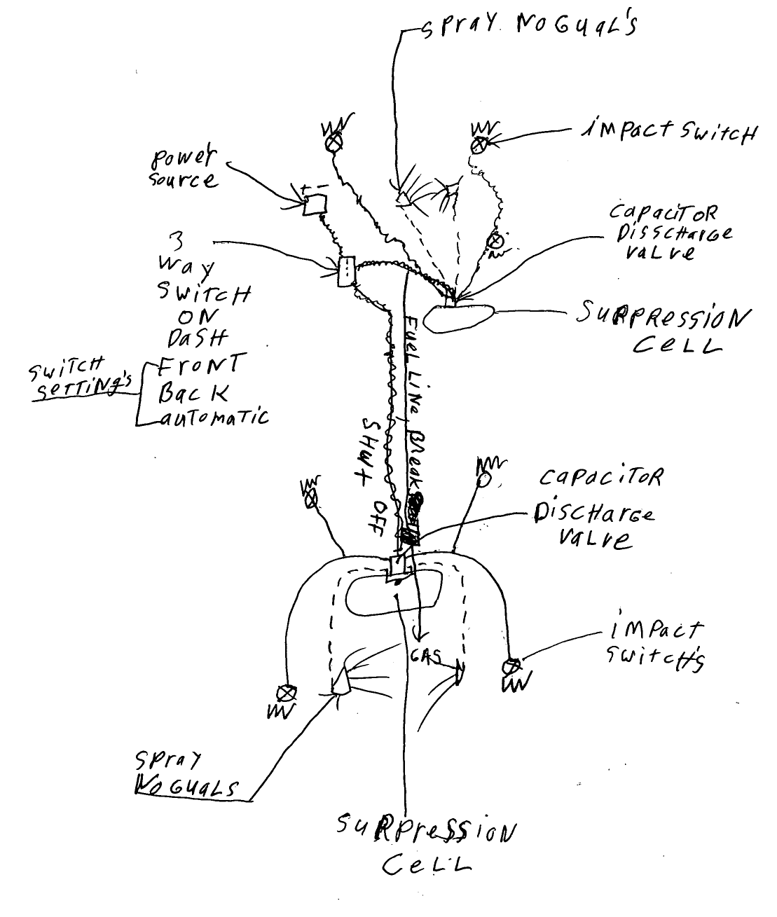

I believe that a high impact fire protection system would be an asset to automobile manufacturers. I believe by manufacturing this product it will save many lives.

This system is made of suppression cells, impact switches, and a three-way dash switch. This switch has a setting for front and rear. Automatic switch has impact switches ready for discharge of suppressant cells to put out a fire. Impact switches placement number should be left to manufacturer. They can be remote controlled from switch to discharge tank. Spray noguals are placed in strategic places around gas tank and motor of automobile. The suppressant cells have a capacitor control valve hook directly to impact switches and dash switch. It also has a smoke and fire detector both on the motor and gas tank. Estimated time for suppressant cell discharge is thirty seconds. The gas tank will also be a switch itself. It should have a very absorbent material surrounding it. The system can be automatic by the way of impact switches. The three-way dash switch has a manual setting for front and rear of the vehicle and a neutral system that is automatic. The dash switch can be manually controlled by the driver to the motor system or to the gas tank. Impact switches and suppressant cells should be placed in the most efficient place. Impact switches vary from one type of vehicle to another. Height and placement is very important to the protection system. The fuel line has a switch to cut off from fuel to the tank in case of collision. The power source will be battery, separate from auto system or intergraded with auto system. I stress that placement of impact switches is critical in performance of this system. Spray noguals will cover a large area in both front and back systems. They also should be placed in a strategic place left to manufacturer. Also left to the manufacturer is the number of noguals. Switches in every make of vehicle would vary. Noguals would also spray under total automobile. The system would also protect from non-impact fires.

1. I believe that my system would greatly reduce risk of fire in automobiles.
